(19) United States
(12) Patent Application Publication
(10) Pub. No.: US 2016/0048378 A1
(43) Pub. Date: Feb. 18, 2016

(54) METHOD FOR ENABLING INDEPENDENT COMPILATION OF PROGRAM AND A SYSTEM THEREFOR

(71) Applicant: Pradeep VARMA, (US)

(72) Inventor: Pradeep VARMA, Gurgaon (IN)

(21) Appl. No.: 14/648,606

(22) PCT Filed: Mar. 29, 2014
(86) PCT No.: PCT/IB2014/060291

§ 371 Date: May 29, 2015

(30) Foreign Application Priority Data
Apr. 4, 2013 (IN) 1013/DEL/2013

(51) Int. Cl. G06F 9/45

(52) U.S. Cl. CPC G06F 8/434

(57) ABSTRACT

A method and system for enabling independent or separate compilation of a program in a memory access and management system including one or more intraprocedural static analyses including an analysis with a first step mapping layouts or types to keys locally, file-by-file, obliviously followed by a second step providing a re-mapping of the layouts to keys globally, cognizant of all files in a program.

### FIELD OF THE INVENTION

The present invention relates to a novel static analysis for the system based on symbolically running a program at compile time.

### BACKGROUND OF THE INVENTION

Memory safety in the context of C/C++ became a concern a decade or so after the advent of the languages. T. M. Austin, S. E. Breach, and G. S. Sohi, “Efficient detection of all pointer and array access errors”, Proc. ACM SIGPLAN 1994 Conf. Programming Language Design and Implementation (Orlando, Fla., United States, Jun. 20-24, 1994), (PLDI '94), ACM, New York, pp. 290-301, DOI=http://doi.acm.org/10.1145/178243.178446 (Austin et al.) described a memory access error as a dereference outside the bounds of the referent, either address-wise or time-wise. The former comprises a spatial access error e.g. array out of bounds access error, and the latter comprises a temporal access error e.g. dereferencing a pointer after the object has been freed. Austin et al. provided the first system to detect such errors relatively precisely (viz. temporal access errors, whose treatment earlier had been limited). However, the work had limited efficiency (temporal error checks had a hash-table implementation with worst-case linear costs; for large fat pointer structures, register allocation was compromised with accompanying performance degradation; execution-time overheads were benchmarked above 300%). The fat pointers also compromised backward compatibility. Significant work has transpired since Austin et al. on these error classes because of the very hard to trace and fix attributes of these errors. The insight of Austin et al. into temporal access errors, namely that object lifetimes can be caught as a pointer attribute, a capability, has led to several works—Electric Fence, PageHeap, its follow-ons in D. Dhurjati, and V. Adve, “Efficiently Detecting All Dangling Pointer Uses in Production Servers”, Proc. Int. Conf. Dependable Systems and Networks (June, '06) (DSN '06), IEEE Computer Society, Washington, D.C., pp. 269-280 (hereinafter referred to as Dhurjati 1) and P. Varma, R. K. Shyamasundar, and H. J. Shah, “Backward-compatible constant-time exception-protected memory”, Proceedings of the 7th joint meeting of the European software engineering conference and the ACM SIGSOFT symposium on The foundations of software engineering, ESEC/FSE '09, pp. 71-80, New York, N.Y., USA, 2009 (hereinafter referred to as Varma 1).

R. W. M. Jones, and P. H. J. Kelly, “Backwards-compatible bounds checking for arrays and pointers in C programs”, Automated and Algorithmic Debugging, Linkoping, Sweden, pages 13-26, 1997 (hereinafter referred to as Jones et al.) present a table-based technique for checking spatial memory violations in C/C++ programs. Standard pointers are used unlike fat pointers of prior spatial access error checkers obtaining significant backwards compatibility as a result. O. Ruwase, and M. Lam, “A practical dynamic buffer overflow detector”, Proc. Network and Distributed System Security (NDSS) Symposium, February 2004, pp. 159-169 (hereinafter referred to as Ruwase et al.) extend Jones et al with out-of-bounds object that allow inbound-pointer-generating arithmetic on an out-of-bounds pointer. D. Dhurjati, S. Kowshik, and V. Adve, “SAFECode: enforcing alias analysis for weakly typed languages”, Proc. ACM SIGPLAN 2006 Conf. Prog. Language Design and Implementation, SIGPLAN Not. 41, 6 (Jun. 2006), pp. 144-157, DOI=http://doi.acm.org/10.1145/1133255.1133999 (hereinafter Dhurjati 2) develops upon Jones et al. and its extension Ruwase et al. by using automatic pool allocation to partition the large table of objects.

A. Loginov. S. H. Yong, S. Horwitz, and T. W. Reps, “Debugging via Run-Time Type Checking”, Proc. 4th International Conf. Fundamental Approaches To Software Engineering (Apr. 2-6, 2001), H. Huβmann, Ed. LNCS vol. 2029, Springer-Verlag, London, pp. 217-232 (hereinafter Loginov et al.) presents a run-time type checking scheme that tracks extensive type information in a “mirror” of application memory to detect type-mismatched errors. The scheme concedes expensiveness performance-wise (due to mirror costs) and does not comprehensively detect dangling pointer errors (fails past reallocations of compatible objects analogous to Purify).

R. Hastings, and B. Joyce, “Purify: Fast detection of memory leaks and access errors”, Proc. Usenix Winter 1992 Technical Conference (San Francisco, Calif., USA, January 1992), Usenix Association, pp. 125-136 (hereinafter referred to as Purify) maintains a map of memory at run-time in checking for memory safety. It offers limited temporal access error protection (not safe for reallocations of deleted data) and fails for spatial access errors once a pointer jumps past a referent into another valid one. Valgrind, as described in N. Nethercote, and J. Seward, “Valgrind: a framework for heavyweight dynamic binary instrumentation”, Proc. ACM SIGPLAN Conf. on Programming Language Design and Implementation (June 2007), (PLDI '07), ACM, New York, N.Y., pp. 89-100. DOI=http://doi.acm.org/10.1145/1273442.1250746; and J. Seward, and N. Nethercote, “Using Valgrind to detect undefined value errors with bit-precision”, Proc. USENIX Annual Technical Conference (Anaheim, Calif., April 2005), USENIX '05, USENIX Association, Berkeley, Calif., provides a dynamic binary instrumentation framework tests for undefined value errors and offers Purify-like protection up to bit-level precision.

CCured as described in J. Condit, M. Harren, S. McPeak, G. C. Necula, and W. Weimer, “CCured in the real world”, Proc. ACM SIGPLAN 2003 Conf. on Programming Language Design and Implementation (San Diego, Calif., USA, Jun. 9-11, 2003) (PLDI '03), ACM, New York, N.Y., pp. 232-244, DOI=http://doi.acm.org/10.1145/781131.781157; and G. C. Necula, S. McPeak, and W. Weimer, “CCured: type-safe retrofitting of legacy code”, Proc. 29th ACM SIGPLAN-SIGACT Symposium on Principles of Programming Languages (Portland. Oreg., Jan. 16-18, 2002), (POPL '02), ACM, New York, N.Y., pp. 128-139. DOI=http://doi.acm.org/10.1145/503272.503286 (hereinafter Necula et al.) provides a type inference system for C pointers for statically and dynamically checked memory safety. The approach however ignores explicit deallocation, relying instead on Boehm Weiser conservative garbage collection (as mentioned in H. Boehm, “Space efficient conservative garbage collection”, Proc. ACM SIGPLAN 1993 Conf. Prog. Language Design and Implementation (Albuquerque, N. Mex., United States, Jun. 21-25, 1993), R. Cartwright, Ed. PLDI '93, ACM, New York, N.Y., pp. 197-206, DOI=http://doi.acm.org/10.1145/155090.155109) for space reclamation. It also disallows pointer arithmetic on structure fields (as mentioned in Necula et al). The approach creates safe and unsafe pointer types all of which have some runtime checks.

Cyclone as described in T. Jim, J. G. Morrisett, D. Grossman, M. W. Hicks, J. Cheney, and Y. Wang, “Cyclone: A Safe Dialect of C”, Proceedings of the General Track: 2002 USENIX Annual Technical Conference (Jun. 10-15, 2002), C. S. Ellis, Ed. USENIX Association, Berkeley, Calif., pp. 275-288, is a significant enough type-safe variant from ANSI C to require significant porting effort of C programs. In Cyclone, dangling pointers are prevented through region analysis and growable regions and garbage collection. Free( ) is a no-op, and gc carries out space reclamation. Oiwa's Fail-Safe C as described in Y. Oiwa, “Implementation of the memory-safe full ansi-C compiler”, Proceedings of the 2009 ACM SIGPLAN conference on Programming language design and implementation, (PLDI '09), pp. 259-269, New York, N.Y., USA, 2009, uses gc for memory reuse ignoring user-specified memory reclamation. Oiwa is also fairly expensive in its implementation costs, for example for fat integers etc. S. Nagarakatte, J. Zhao, M. M. Martin, and S. Zdancewic, “Softbound: highly compatible and complete spatial memory safety for C”, Proceedings of the 2009 ACM SIGPLAN conference on Programming language design and implementation, (PLDI '09), pp. 245-258, New York, N.Y., USA, 2009 (hereinafter Nagarkatte et al.) are similarly expensive in the table based methods they provide.

E. D. Berger, and B. G. Zorn, “DieHard: probabilistic memory safety for unsafe languages”, Proc. ACM SIGPLAN 2006 Conf. Prog. Language Design and Implementation, SIGPLAN Not. 41, 6 (Jun. 2006), 158-168, DOI=http://doi.acm.org/10.1145/1133981.1134000 (hereinafter referred to as Berger et al.) presents a randomized memory manager approach to handling memory safety errors by increasing redundancy (replicating computation; and multiplying heap size, which is similar to Purify's larger heap requirements in support of heap aging). T. M. Chilimbi, and M. Hauswirth, “Low-overhead memory leak detection using adaptive statistical profiling”, ASPLOS 2004, SIGPLAN Not. 39, 11 (November 2004), pp. 156-164, DOI=http://doi.acm.org/10.1145/1037187.1024412 (hereinafter referred to as Chilimbi et al.) suggests use of sample-based adaptive profiling to dynamically build and monitor a heap model, identifying long-unused, stale objects as potential leaks. F. Qin, S. Lu, and Y. Zhou, “SafeMem: Exploiting ECC-Memory for Detecting Memory Leaks and Memory Corruption During Production Runs”, Proc. HPCA (Feb. 12-16, 2005), IEEE Computer Society, Washington, D.C., pp. 291-302 (hereinafter Qin et al.) experiments with using hardware error correcting codes (ECC) in detecting memory violations/leaks in a manner analogous to the page protection mechanism.

Despite the above-mentioned teachings, which are being incorporated herein in totality for all useful purposes, to the best of the Applicant's knowledge, no prior work has attempted secure program optimization based on such symbolic analysis to the best of our knowledge. Thus, there exists a need to provide improved methods of program optimization analysis for a memory-safe system based on symbolically running a program at compile time.

### SUMMARY OF THE INVENTION

Accordingly, the present invention provides a method for enabling independent compilation in a system, comprising:
identifying unique layouts in a pre-processed file or translation unit of a program and assigning unique keys to all the identified unique layouts;
creating a local table and populating the same with the unique layouts and their associated unique keys;
repeating the aforesaid steps for all pre-processed files or translation units corresponding to the program to thereby generate a set of local tables, wherein each of the local table in the set corresponds to a particular file;
creating a global table and populating the same with layouts taken from the set of local tables, such that each entry in the global table is unique; and substituting each layout in each local table by a pointer to the associated unique entry in the global table, thereby linking the local tables and the global table to enable independent compilation of each file in the program.

In an embodiment of the invention, assigning comprises assigning unique keys to all the identified unique layouts in a sequential order.

In another embodiment of the invention, a layout defines a pair comprising the global/mangled function name, and the complete type of the function. For such a layout, the function address or function pointer serves as the unique key and the tables are constructed as an association list of key layout pairs. This method constructs a useful global table of function pointer, function record pairs, where the function record can be augmented further to include an encoded pointer value for the function, etc.

In another embodiment of the invention, the pointer may be a live pointer, dangling pointer, inbound pointer, out-of-bounds pointer, uninitialized pointer, manufactured pointer or hidden pointer.

In another embodiment of the invention, wherein one or more files independently compiled of each other assigns different keys to the same layout or different layout to the same key.

In an embodiment, running or analyzing a secure or safe program symbolically wherein symbolic program values or uvs are defined with the constraints of their storage memory comprising one stack frame or heap allocations and pointer/variable/parameter aliasing is constrained by the secure language context.

In another embodiment, wherein a stack frame allocated variable or parameter is constrained to not be aliased with a pointer accessible location.

In another embodiment, wherein a location in one heap allocated object is constrained to not be aliased with locations accessible to a pointer to different heap allocated object, regardless of pointer arithmetic carried out on the pointer.

In another embodiment, wherein a location, variable or parameter containing a pointer scalar is constrained to not be aliased with a location or variable or parameter containing a non-pointer scalar.

In another embodiment, the secure dialect or language of the symbolic analysis is secure C/C++.

In another embodiment, analyzing a secure or safe program statically wherein static program values are defined with the constraints of their storage memory comprising one stack frame or heap allocations and pointer/variable/parameter aliasing is constrained by the secure language context.

In another embodiment, comprising symbolically tracing an assertion through the succeeding program to establish domination or effective domination of the assertion over dereferences and post-domination or effective post-domination of dereferences over the assertion, thereby allowing the asserted properties to represent bulk security checks for the dereferences.

In another embodiment, a symbolic static analysis is provided for verifying always-safe or always-unsafe dereferences according to assertions of liveness, inboundedness, excursion or type-layout properties in the program.

In yet another embodiment, symbolic tagging of the static program trace with program values is carried out to identify dereferences with program values in order to establish the coverage of the dereferences by the asserted properties.

In yet another embodiment, wherein inserting liveness assertions post skipped calls in the intraprocedural analysis to allow the analysis to continue past free( ) calls that are happenable in the skipped calls.

In still another embodiment, symbolically tracing a program and inferring an assertion to be placed at a program point is carried out so that the assertion dominates or effectively dominates succeeding dereferences and is post-dominated or effectively post-dominated by the dereferences such that the inferred properties for the assertion cover the dereferences and represent bulk security checks for the dereferences.

In a further embodiment, the program points include the entry to a procedure and compliance operation positions including pointer casts, stored pointer reads, and pointer arithmetic operations.

In a furthermore embodiment, the inferred property to be asserted comprises disjunction of fast and slow checks allowing the common case to be processed fast.

In an embodiment, the fast and slow checks comprise type-layout checks, and loose or exact coverage checks in liveness, inboundedness or excursion clauses.

In another embodiment, inserting liveness assertions post skipped calls in the intraprocedural analysis to allow the analysis to continue past free( ) calls that are happenable in the skipped calls.

In an embodiment, establishing encoded pointers passed to a try block in a program as single-word encoded pointers is carried out including supporting pointers in the program annotated with a single word qualifier.

In another embodiment, propagating single-word pointers through a program by reachability of types is carried out that identifies pointers stored in objects pointed to by singleword pointers as singleword pointers and identifies pointers to objects containing singleword pointers as singleword pointers and identifies pointers co-habiting a data structure with a singleword pointer as singleword pointers.

In yet another embodiment, runtime implementation of singleword pointers increases the number of pointer bits available for versions and other metadata by reducing the object's base pointer by a constant number C of bits and increases the stride of base pointer by 2̂C bytes in order to leverage the minimum stride among adjacent heap objects.

In yet another embodiment, runtime implementation of doubleword pointers increases bits for their metadata in a similar manner.

In still another embodiment, the identified singleword pointers are further verified to be implementable thus by a further intraprocedural static analysis that is simplified by requiring that pointers passed to a procedure (in a call) or stored in a data structure or a global variable be demonstrably inbound by either a dominating dereference or an analysis placed assertion.

### BRIEF DESCRIPTION OF THE ACCOMPANYING DRAWINGS

These and other features, aspects, and advantages of the present invention will become better understood when the following detailed description is read with reference to the accompanying drawings in which like characters represent like parts throughout the drawings, wherein:

FIG. 1 represents a flow chart of the method in accordance with one aspect of the description;

FIG. 2 represents a block diagram showing an example for enabling independent compilation in a system;

FIG. 3 represents a flow chart of an optimization analysis method in accordance with an embodiment of the description;

FIG. 4 represents a storage model created by following the intra procedural method in accordance with an embodiment of the description;

FIG. 5 represents a flow chart for a bulk check automation or assertion inference analysis in accordance with an embodiment of the description; and

FIG. 6 shows a block diagram of a system configured to implement the method in accordance with one aspect of the description.

It may be noted that, to the extent possible, like reference numerals have been used to represent like elements in the drawings. Further, skilled artisans will appreciate that elements in the drawings are illustrated for simplicity and may not have been necessarily been drawn to scale. For example, the dimensions of some of the elements in the drawings may be exaggerated relative to other elements to help to improve understanding of aspects of the present invention. Furthermore, the one or more elements may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

It should be noted that the steps of a method may be providing only those specific details that are pertinent to understanding the embodiments of the present invention and so as not to obscure the disclosure with details that will be readily apparent to those of ordinary skill in the art having benefit of the description herein. Similarly, parts of a device have been represented where appropriate by conventional symbols in the drawings, showing only those specific details that are pertinent to understanding the embodiments of the present invention so as not to obscure the disclosure with details that will be readily apparent to those of ordinary skill in the art having benefit of the description herein.

As used in the description, reference throughout this specification to “an embodiment”, “another embodiment” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

It should be noted that as used in the description herein, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention.

Groupings of alternative elements or embodiments of the invention disclosed herein are not to be construed as limitations. Each group member can be referred to individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

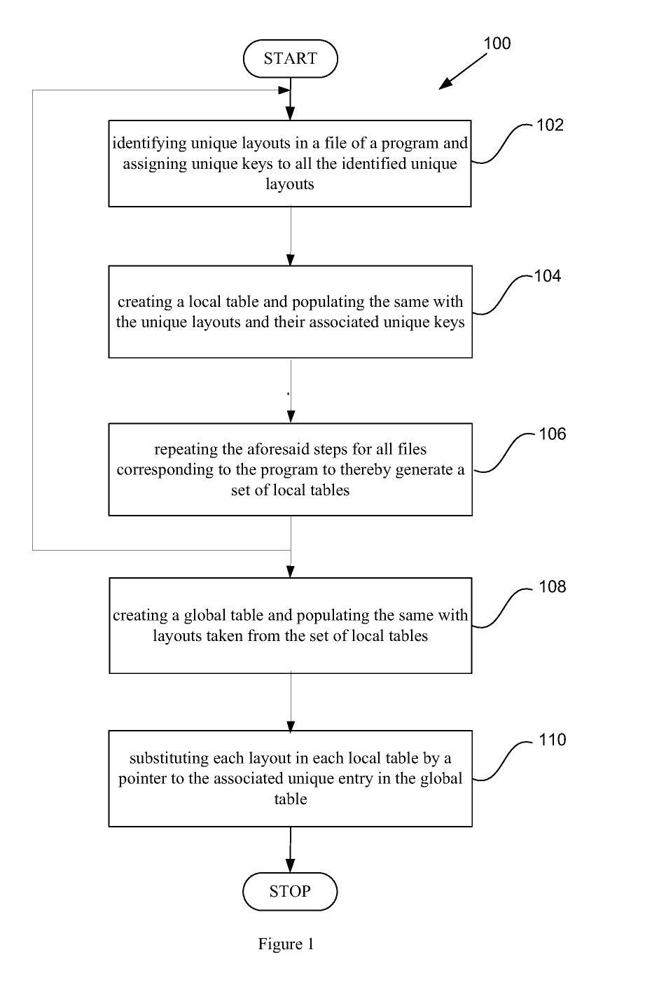

Referring to FIG. 1, the present invention provides a method (100) for enabling independent compilation in a system, comprising:
identifying (102) unique layouts in a pre-processed file or translation unit of a program and assigning unique keys to all the identified unique layouts;
creating (104) a local table and populating the same with the unique layouts and their associated unique keys;
repeating (106) the aforesaid steps for all pre-processed files or translation units corresponding to the program to thereby generate a set of local tables, wherein each of the local table in the set corresponds to a particular file;
creating (108) a global table and populating the same with layouts taken from the set of local tables, such that each entry in the global table is unique; and
substituting (110) each layout in each local table by a pointer to the associated unique entry in the global table, thereby linking the local tables and the global table to enable independent compilation of each file in the program.

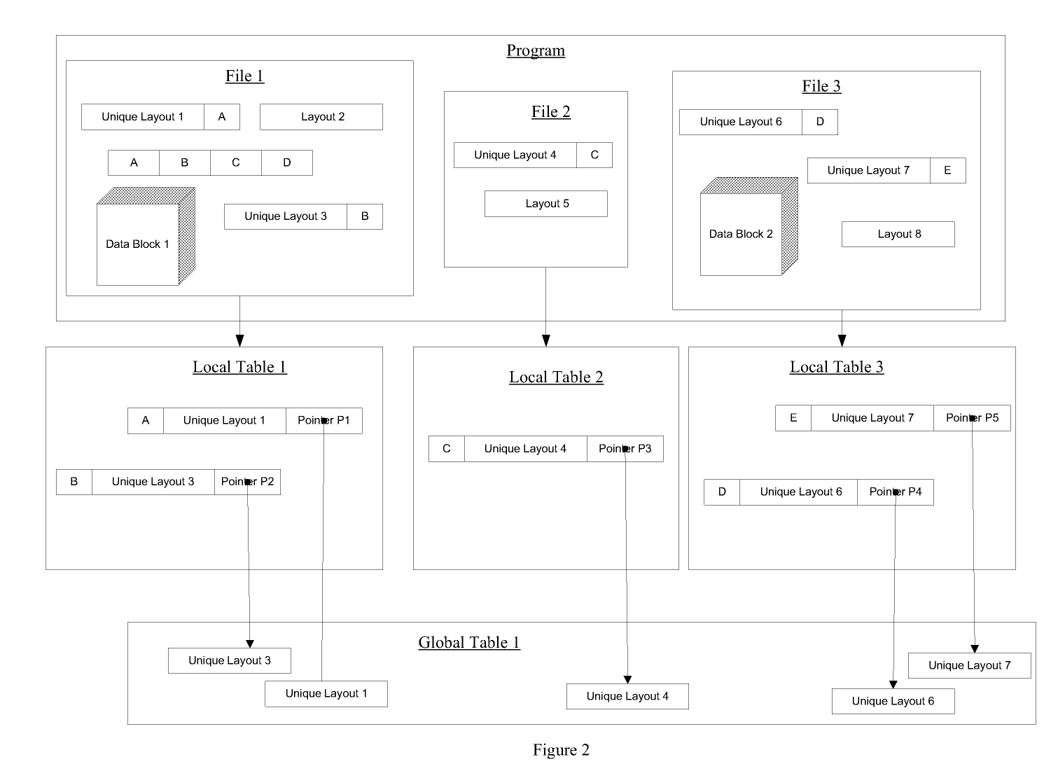

FIG. 2 illustrates a block diagram showing an example for enabling independent compilation in a system. FIG. 2 illustrates a program having three pre-processed files namely File 1, File 2 and File 3. According to an embodiment, the program may contain one or more files. Every file of the program may comprise of data, variable, functions, layouts such as type layouts, arrays, lists, etc.

File 1 comprises of layout 1, 2, 3 of which layout 1, 3 are unique within the pre-processed file, an array and a data block 1. Layout 2 of the file is not unique and repeats one or the other of layouts 1 and 3. File 2 comprises of layout 4, 5 of which layout 4 is unique within File 2. File 3 comprises of layout 6, 7, 8 of which layout 6, 7 are unique within file 3 and a data block 2. Layout 4 need not be unique if file 1 and file 2 are viewed together and may repeat one or the other of layouts 1 and 3. However for illustrative purposes in this example, we are assuming that all file-specific unique layouts are also unique globally. According to another embodiment, the uniqueness of the layout may depend on various factors determined by the program and executed by a processor.

Further, all the identified unique layouts 1,3,4,6,7 are assigned file-specific or local unique keys A,B,C,D,E by the processor. A non-unique layout in a file is assigned the key of the unique layout it duplicates. This is not shown in FIG. 2 to reduce clutter. Since the keys are local and unique within a file only, they may be repeated when moving from one file to another. So for instance key C of file 2 may repeat key A of file 1. The file-specific, local unique keys A,B,C,D,E maybe identification tags for the layouts or may be an index for an array or pointer referring to an address location in the memory.

Further, one or more Local Tables may be created in a memory space of the system with each file of a program communicating with a separate local table associated with the file such as File 1 communicates with the Local table 1, File 2 communicates with the Local Table 2 and so on. The local tables are populated with the file-specific local unique layouts 1,3,4,6,7 and their associated local keys A,B,C,D,E such that the layout may optionally be erased from the file and only their associated local keys maybe present in the file to create a link between the file and the local table.

Further, a Global Table 1 may be created in the memory space of the system and populated with the unique layouts 1,3,4,6,7 from the local tables 1,2,3 such that each entry in the global table is unique. For the example shown, all the layouts 1,3,4,6,7 are distinct, hence each of them gets to be entered in the global table. Each unique layout 1,3,4,6,7 in the local table 1,2,3 may be substituted by a pointer P1, P2, P3, P4, P5 to its associated unique entry in the global table, thereby linking the local tables and the global table to enable independent compilation of each file in the program.

After the above method is executed, the files of the program may have the associated keys A,B,C,D,E of the unique layouts, for accessing or indexing local tables 1,2,3. The accessed data in the local table may further refer to another memory location in the global table 1 (using pointers P1, P2, P3, P4, P5) for viewing the unique layout and its associated information.

Independent compilation is a key requirement for scalable deployment of programs. It is imperative therefore that a compiler supports independent compilation fully. In this disclosure, we describe issues that arise for independent compilation in a compiler and provide methods to tackle the issues.

The layout store constructed by the compiler of the present disclosure is a global entity representing assignment of keys to layouts obtained from across all files of the program. Two files compiled independently of each other may assign different keys to the same layout, or different layouts to the same key. We present a method here to allow independent compilation to occur obliviously of each other and yet build a layout store with a shared global key assignment.

The method comprises:

Compile each file by itself, creating a local layout store per file. The keys of the local store are hardwired into the object file. There is also a global, shared layout store associated with the main file. The global store is accessed by looking up the local store entry for a key, which itself is the global store key. Indexing the global store with this key yields the layout sought. In short, the lookup comprises:

global_layouts[file_layouts[file_specific_key]];

This requires one level of indexing more than whole program compilation, wherein the lookup comprises:

Global_layouts[global_key];

In whole program compilation, the keys available directly to code per file are the global keys.

Using one initialization function declared per file, the local and global layout stores are updated as follows. The file-specific initialization function, file_init( ) refers to the global layout store, available as an extern variable, and updates it to include the collection of layouts from the file. It also updates the file_layouts[ ] array to point its entries to the updated global layout store (updated with the file's entries). After file_init( ) has been called, file_layouts[ ] becomes a read-only store, which remains fixed for the entire duration of the program. The Global_layouts[ ] store becomes temporary read-only after all files have carried out their initializations. Global_layouts[ ] is temporarily fixed, because the next dynamic linking of files during program run can update it further.

The above scheme costs one array dereference more than whole program analysis. This is inexpensive enough to be a general solution for all needs. However, if a user really insists on whole program analysis, that can be made available as a compiler option.

An important attribute of the above approach is that complete sharing of type layouts is preserved by the scheme. In other words, each layout has one and only one global key associated with it. So each layout is stored in only one location in the global store. There is no duplication of layouts in the global store, despite the multiple, independently compiled origins of layouts/types in the program.

Another important attribute of the above approach is that it affords make files to be used as is. Each file-specific compilation runs in multiple passes over the same file, one pass generating the file-specific definitions (e.g. file_layouts[ ]), another pass restructuring and compiling the file code. The linker is modified as follows. The linker generates a function to call all the file_init( ) functions for the linked files. This function is not defined in any of the compiled files and is called as one of the initialization steps by main( ). Thus all compiler executable-building compilations involve the linker, even if a single file is compiled (trivially). This is a part of the call to the compiler.

The file_init( ) function can also do an extra step for function pointer initialization as follows. The function builds function pointer records for all the functions defined in its file and augments a global store (an extern variable) with these records. After all file_init( ) functions have been called, the global store can be accessed using a function pointer as a key to yield an encoded pointer value (epv) for the function pointer with the epv pointing to the full record of the function e.g. type as usual. The global store in effect yields a lookup table for epv/record data of each function pointer. The lookup table access is used to replace code where the address of a function is taken with table lookup for the epv of the function pointer.

The function pointer initialization step may also be carried out leveraging the global layouts store construction as follows. For each function definition define a layout as a pair comprising the global/mangled function name, and the complete type of the function. For such a layout, define the function address or function pointer as a key for the function. Now apply the global table construction algorithm for the functions (FIG. 1), where tables are constructed as an association list of key layout pairs. This method constructs a useful global table of function pointer, function record pairs, where the function record can be augmented further to include an encoded pointer value for the function, etc.

Whole program analysis makes global layout access cheaper by one array dereference. Another benefit is that auxiliary file-specific globals (e.g. functions) defined during compilations get to be shared among files eliminating duplication. Eliminating such duplication during independent compilation may be done as follows: suppose each independently compiled file only refers to auxiliary function prototypes but does not define them in its compilation. Then the linker has to provide these functions finally. Now if the prototype name identifies uniquely, the function body that is to be provided, then the linker can be made to generate these functions automatically when linking independently-compiled compiler files. This eliminates all auxiliary function duplication.

### Memory Access Optimization

Symbolic execution or running of a program symbolically is described in “James C. King. 1976. Symbolic execution and program testing. Commun. ACM 19, 7 (July 1976), 385-394. DOI=10.1145/360248.360252 http://doi.acm.org/10.1145/360248.360252” (hereinafter referred to as King); “Lian Li, Cristina Cifuentes, and Nathan Keynes. 2010. Practical and effective symbolic analysis for buffer overflow detection. In Proceedings of the eighteenth ACM SIGSOFT international symposium on Foundations of software engineering (FSE '10). ACM, New York, N.Y., USA, 317-326. DOI=10.1145/1882291.1882338 http://doi.acm.or/10.1145/1882291.1882338” (hereinafter Lian) and “Corina S. Pasareanu and Willem Visser. 2009. A survey of new trends in symbolic execution for software testing and analysis. Int. J. Softw. Tools Technol. Transf. 11, 4 (October 2009), 339-353. DOI=10.1007/s10009-009-0118-1 http://dx.doi.org/10.1007/s10009-009-0118-1” (hereinafter Corina).

An analyzer for symbolic execution for static analysis purposes called Pundit is described in detail in Pradeep Varma, “Compile-time analyses and run-time support for a higher-order, distributed data-structures based, parallel language”, PhD thesis, Department of Computer Science, Yale University, 1995, New Haven, Conn., USA (hereinafter referred to as Varma95). The analyzer differs from testing-oriented symbolic execution of King and Corina by being focused on static analysis only. Pundit is unique vis-à-vis other symbolic execution systems described in King, Lian and Corina in its fast and scalable decision-making. This arises in part from a simple symbolic value structure—viz. an unknown symbolic value or unknown variable (uv) is used to represent values whose constraints are left unsolved during trace construction. This is similar to introduction of new atomic symbols in Lian to represent combinations of other symbols. Another design decision for Pundit is to carry out focused tracing, from specific starting points in a program. These starting points generally begin part-way through a program computation with the entire environment instantiated at a starting point being comprised of symbolic values of variables (called uvs, short for unknown-values). Tracing from a starting point does not attempt to construct the entire symbolic execution tree or static trace for the remaining program. Tracing very efficiently constructs the largest conservative trace without entering into unbounded unfolding of a loop. Further scaling of the program analysis arises from carrying out tracing from a multitude of starting points in the program.

Pundit is used is this teaching to trace the running of a program statically, starting from individual user assertions in the program. The assertions state properties defined in terms of functions defined by a run-time library for a secure memory access and management system supporting the program e.g. liveness, inboundedness, type-layout, excursion (discussed later). Because the assertions are supported by a run-time library, the assertions are dynamically verified at run-time, with symbolic tracing only accepting the run-time-guaranteed validity of the assertions and establishing further properties of the program, statically, after the assertions. The tracing proceeds as described in Varma95. A salient difference is that it is not carried out inter-procedurally as in Varma95, but rather intra-procedurally for the convenience of separate compilation. The environment is represented by bindings of uvs as in Varma95. One departure from Varma95 is in the storage based representation of uvs for a secure C/C++ context as opposed to the Lisp context of Varma95. Constraints on uvs are storage based constraints placed upon the value represented by a uv additionally to what is described in Varma95. This allows Pundit to carry out bitwise operations on uvs representative of C/C++. The store model used to support environment bindings also differs from Varma95 in order to support the rich aliasing/overlap possible in C/C++, arising from pointer arithmetic, for example. This rich aliasing/overlap model is further informed by the secure context of C/C++ that is analyzed. In short, the changes in Pundit from Varma95 are according to the secure language context that Pundit is embedded in. The difference is simplified by the intraprocedural instantiation of Pundit, which means that stack-based local variables are a focal point whose allocation and deallocation points are within the procedural scope of the analysis with store model aliasing well understood and made secure by the secure language context. By keeping the focus on scalar variables, Pundit is able to offer a concrete static analysis without emulating in the finest detail the flowery nature of the unsecure C/C++ storage model.

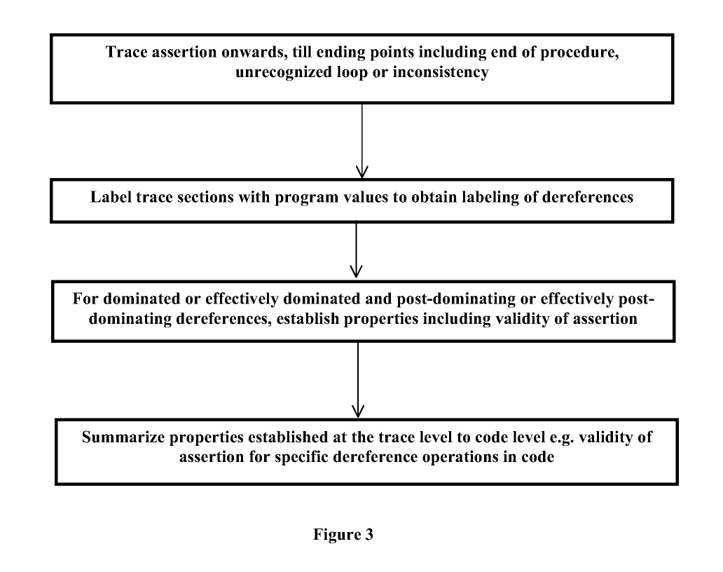

As shown in FIG. 3, which represents a flow chart of the optimization analysis method in accordance with one embodiment, tracing begins from user assertions and continues till it normally ends as in Varma95 upon encountering an unrecognized loop or inconsistency. Further, since the analysis here is intraprocedural, it also ends upon reaching the end of procedure. For simple nested loops, tracing is carried out as in Varma95. Procedure calls are skipped since the analysis is intra-procedural. The consequential effect of a call is that free( ) calls on pointers passed to the procedures are conservatively assumed as happenable. As a compiler option, or with user interaction, analysis persists past happenable free( ) calls by inserting a liveness assertion post a procedural call for pointers that might have incurred free( ) calls. Straightforwardly, the liveness assertion can also be instantiated as a liveness predicate in a conditional, with the consequent executing the validated liveness condition and the alternate executing an invalidated liveness condition. Tracing constructs a static trace of program runs from the assertion point using which properties of specific memory accesses are decided. Accesses or dereferences dominated or effectively dominated by an assertion and which in turn post-dominate or effectively post-dominate the assertion are candidates for having their safety checks represented by the assertion. Effectively dominates means that a set of assertions together dominates a dereference when individually they don't and effectively post-dominates means that a set of dereferences that have the same check represented by an assertion together post-dominate the assertion when individually they don't. Effectively dominates and effectively post-dominates also means individual or set based domination/post-domination in the possible run-time or dynamic traces of the program regardless of whether the domination/post-domination is apparent in the code-level control flow graph of the program. The possible run-time or dynamic traces of the program are represented by the static trace of the program and the static trace is analyzed for this purpose. The key element of this analysis is the identification or labeling of trace sections with program values such as index spaces of iterations. Thus memory accesses within a loop get identified individually as indexed operations. Properties established at this level of granularity are then collapsed to the code level of granularity where trace sections are folded back as code. That a pointer is inbounded with specific space for inbounded excursion etc. may be asserted and used above. This is shown in the example below. In the example below, pointer p is asserted to be live, inbound to its associated object, and be incrementable by N bytes before running out of bounds of the pointed object. Another interpretation of forward space(p) is that pointer p be incrementable by N bytes before running into an (encoded) pointer stored in the associated object according to its object layout. Thus pointer p can be used to freely read/write bytes to the object using pointer arithmetic for upto N byte increments, prior to attempting an (encoded) pointer overwrite or going out of bounds. Thus excursion functions such as forward space and similarly backward space that express free or allowed excursion regions of a pointer within an object, according to its layout, after or before the pointer may be expressed as asserted properties in an assertion. Alternatively, disallowed, non-excursion regions of an object may also be asserted as properties, as regions to be avoided. Another property that may be explicitly asserted is the equality or non-equality of a pointer to the (encoded) null pointer. Another property that may be explicitly asserted is the layout key for the object pointed by a pointer (e.g. object layout is standalone string) and the pointer's position in the layout key (e.g. pointer is a base pointer to the layout).

Example: Consider the following program fragment.
assert (live(p) && inbound(p) && forwardspace(p)=N);
for (i=0; i<N; i++) (*(p+i)= . . . ; )

The example shows a function body. In the example, the N characters are written to a character array. The assertion states that the character pointer p points to a live object; the pointer is inbound, and that ahead of where p points in the object, there is allocated space for N characters. The Pundit's analysis traces the function from the assertion onwards, building a static trace that unrolls the loop exactly once within which it acquires the structure of the loop and its variables. With this information, the iteration space of the loop becomes available, along with a labeling of its individual iterations with the index i. This allows the dereferences *(p+i) to be labeled and the assertion verified over the entire loop.

### Pundit Store Model

The store model emulates memory allocation symbolically. Since Pundit is used intraprocedurally, only the present stack frame needs to be constructed. The present frame is built with constant offsets starting from a symbolic frame pointer. Heap allocations similarly occur from symbolic object base pointers. Uvs are the usual, except that they also have a constraint specifying the storage they reside in, thereby constraining the values representable by the uv. Constraints are the usual, except that they may also add bit pattern specifications on the uvs/locations.

To the above, the embedding in a secure C/C++ context adds the following features. Stack allocated variables accessed by a pointer are shifted to the heap, which means the stack cannot be accessed by a user-created pointer, regardless of pointer arithmetic. Similarly, a pointer to a heap allocated object can access only that object and not access any other object, regardless of pointer arithmetic. This means that the local variables on stack, scalar or otherwise, are unaffected by an unknown pointer write since the unknown pointer cannot overwrite the stack. Similarly, if an unknown pointer is known to be associated with a particular object, then all writes using that pointer are known to not affect the contents of other objects. Compliance constraints add the guarantee that a pointer to a pointer cannot be written to affect non-pointer containing locations. Conversely, a pointer to a non-pointer cannot be written to affect pointer-containing locations. Thus an unknown pointer to a pointer access is guaranteed to not affect scalars containing non-pointer values. An unknown pointer to non-pointer access is guaranteed to not affect scalars containing pointer values. Since unknown pointers can easily be encountered in static analysis, these guarantees are crucial in continuing analysis with (partially) known variables/objects despite unknown pointer writes. These guarantees are crucial in enhancing the precision of the static analysis.

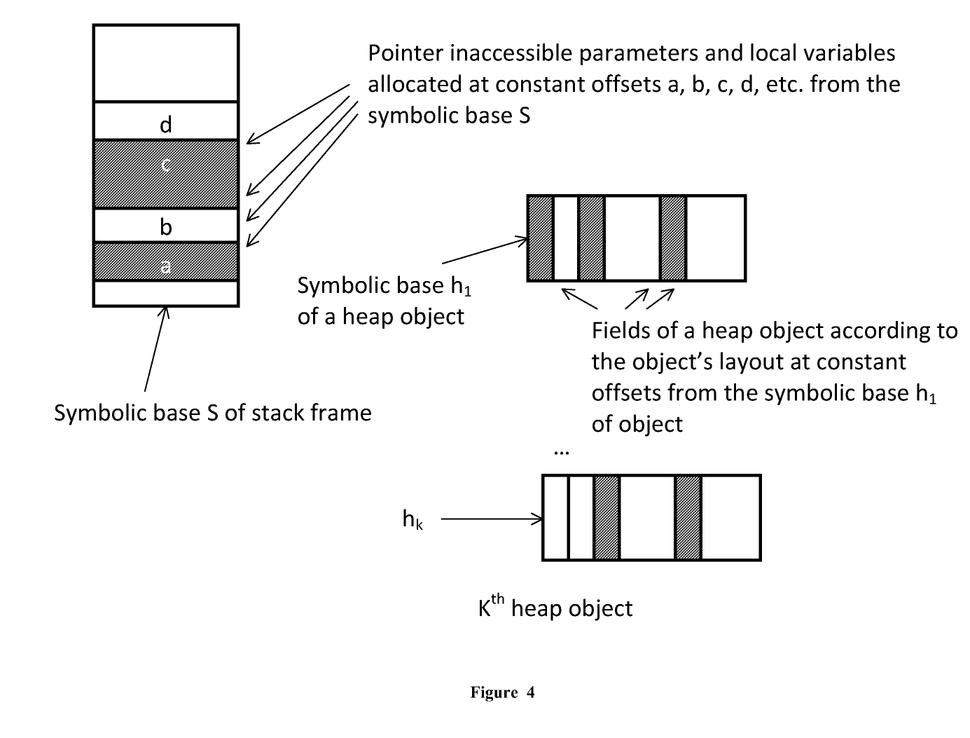

FIG. 4 illustrates a storage model created by following the intra procedural method in accordance with an embodiment of the description. The single stack frame is shown and all variables, procedure parameters stored on it are insulated from pointer access. The stack frame has a symbolic base and individual variables/parameters allocated on it have known constant offsets from the symbolic base. Heap objects are laid out separately, with pointers to a heap object being capable of accessing that one object only, exclusively. A heap object or stack allocated entity can only be accessed according to its layout. The layout recognizes stored pointers and stored non pointers distinctly and they are colored in grey and white respectively. Accesses to grey cannot be aliased with accesses to white and vice versa.

For the layout of a stack frame or activation record, refer to A. V. Aho, R. Sethi, J. D. Ullman, “Compilers Principles, Techniques, and Tools”, Addison-Wesley Publishing Company, June 1987. The stack frame shown in FIG. 4 is illustrative and not meant to show the specific layout of any particular compiler. Due to heapification of pointer-accessed objects, the stack frame does not contain any arrays. Hence, all offsets of objects on the stack frame are constant and pre-known and may be positive or negative depending on the frame layout chosen. Due to the secure context and the non-aliasing of local variables/parameters with pointer-accessed locations, all these variables and temporaries are unaliased in the intraprocedural analysis, greatly simplifying the analysis. Thus from a static analysis perspective, even register-carried parameters can simply be treated as stack allocated and given constant offsets on the stack frame. The only exception to constant offsets of frame-allocated objects occurs when vararg procedures are encountered. In this case, the vararg parameters are laid out with increasing offsets below the symbolic frame pointer while the procedure-local data is laid out with constant offsets above the frame pointer. The vararg parameters carry their types, one per argument, as extra arguments to enable the dynamic type checking of the vararg parameters as they are accessed. FIG. 4 illustrates the common case of a procedure with a fixed number of parameters.

### Bulk Check Automation:

Minimal set of positions for placing such a check are: procedure entry for parameters, compliance check positions viz. pointer casts, stored pointer reads and pointer arithmetic operations. According to an embodiment, the Global variables may also be covered by these checks. A compliance check operation is sought to be turned into a bulk check and a procedure entry is a point for common amalgamation of checks into a bulk one. A bulk check needs to dominate or effectively dominate the dereferences it covers and be post-dominated or be effectively post-dominated by the dereferences in order to shift the safety checks of the dereferences to the bulk check. The bulk check may have three clauses: liveness, type, and inboundedness. If the bulk check is post-dominated by at least one dereference (without intervening free( )), then the liveness clause may be placed. The type clause is standard compliance check, which may be stripped to just a base type id check if it can be established that only a base type may pass that compliance check otherwise it may be a disjunction of a fast check (e.g. base type id) and a slow check. The size of an array type T[N] may be unknown, N unknown, but that is immaterial from the type check perspective. The size counts for the inboundedness check, which establishes the excursion or range of inboundedness. A simple means for handling the size is to let the inboundedness analysis determine it as necessary. The key is to let Pundit proceed as usual from a candidate bulk check position and infer the liveness and inboundedness clauses as conservatively (loosely or exactly, depending upon compiler option or user direction) covering the succeeding dereferences instead of just verifying them in the optimization analysis. In the process, the analysis may place additional liveness assertions post procedure calls, just as in the optimization analysis. This is demonstrated in the example given previously, where a blank assertion is started with initially, the liveness clause constructed given that more than one dereference transpires in the loop body (the knowledge of at least one dereference in the static trace establishes effective post-domination given that post-domination by the code-level control flow edges alone does not establish post-domination; note that establishing effective domination and post domination are particularly the strengths of symbolic analysis because of analyzing traces), the inboundedness clause constructed given that *p is dereferenced and the forwardspace clause constructed, given the set of dereferences of *(p+i).

According to another embodiment, all scalars in FIG. 4 are pointer-sized to simplify alignment illustration. The field at offset c in the stack frame is a struct of two pointers.

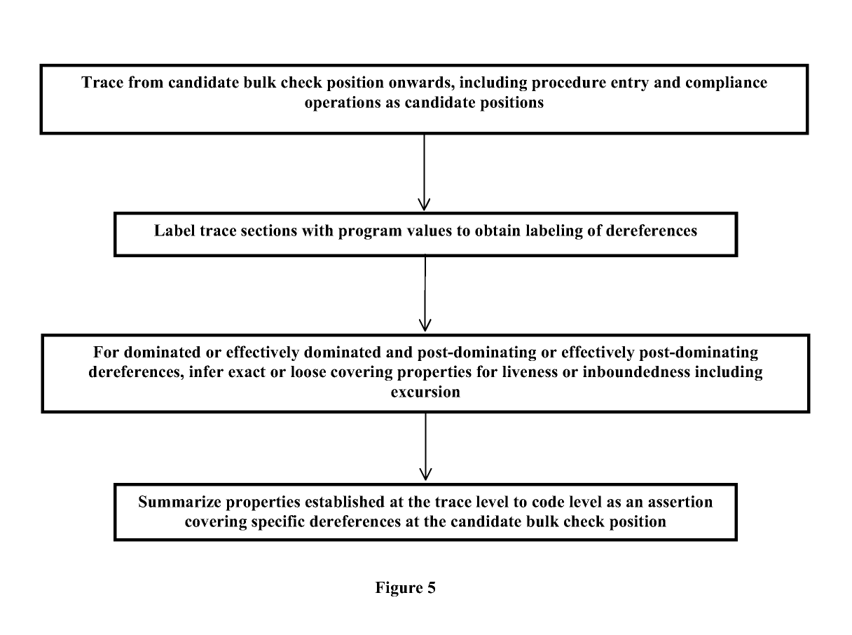

FIG. 5 provides the flowchart for bulk check automation or assertion inference analysis, skipping type clause inference as that is supplied simply by a compliance operation's type check or program types. The inferred assertion may be presented as a fast and slow checks disjunction, with the fast check leveraging a type-layout check such as asserting pointer to be a base pointer to a specific layout. The fast check can also leverage loose coverage by liveness and inboundedness clauses, with the exact check being the slow check.

### Try Block of Backward Compatibility:

In singleword encoded pointer (ep) implementations of the language, there is no need to copy data structures for backward compatibility. In this case, the free variables of the try block may comprise pointers. At the entry to the try block, the epvs in the free variables can be recursively traced out to walk the corresponding data structures (layouts are available), translating their stored epvs to decoded pointers. At the exit, the reverse walk can be done on the same variables. So nothing is expected of the user in terms of extra work for backward compatibility.

A doubleword ep implementation can use singleword pointers for the try blocks as follows. Require the type of the free variable pointers to be sepv, where s stands for singleword. Now demand that the stored pointers in the objects of the free variables be also typed sepv. Now propagate sepv throughout the program by reachability and require that a type be either sepv or epv but not their union. For such an sepv characterization, the representation of objects remains the same. The layout store is bifurcated into two, one for singleword pointers, another for doubleword pointers for the convenience of garbage collection. For try blocks that do not meet the requirements above, the free variables can be required to be scalar non-pointers as before and the programmer mediate to copy and decode/encode as before. For the try blocks meeting the requirements above, the encoding/decoding of pointers can be carried out automatically at the entry/exits of try blocks.

Better reach for sepvs: The free pointer variables of the try block are typed sepv. Do sepv reachability (on types) as follows: a pointer obtained from dereferencing an sepv is also typed sepv; a pointer from which an sepv is obtained by dereferencing is typed sepv; a pointer cohabiting a data structure with an sepv is an sepv; an pointer cast of an sepv is also an sepv. Do this till no more types in the program can be typed sepv. All the remaining pointer types are epv. Check that the epv types do not reach sepv types this is flagged as disallowed.

From a runtime perspective, now pointers are a mix of sepvs and epvs. Let each object layout be flagged sepv or epv based. From a precise collector perspective, this poses no difficulty as each precise pointer's size is known from context. From a conservative collector perspective, this poses no difficulty as both single-sized and double-sized filtering can be carried out and the object's pointer size is known from its layout. Similar is the case for encode and decode. Just the layout stores are independent (for sepv and epv). The object management queues remain the same and are shared. Furthermore, for sepvs, the heap can be managed as a smaller quantity within the larger full heap. Thus the metadata for the sepvs and epvs become different, allowing a smaller HEAP_OFFSET_BITS for the sepvs (user specified), freeing up more bits for intra-object offsets and versions. Further bits can be freed up given the following observation. Objects in the compiler heap are all doubleword aligned. Hence in an object's address, the lower 3 or 4 bits are unused (for 32-bit and 64-bit implementations respectively). Hence these 3 to 4 bits are all Os in the object base pointer bitfield of an encoded pointer which means that these bits can be reclaimed. With such a reclamation and other savings of bits, the free bits for versions and intra-object offsets increases making sepv (also doubleword epv) implementations convenient.

From an independent compilation perspective, a pointer qualifier, single, is introduced to annotate pointers that need to be made sepvs. All pointers in try block are implicitly single. For sepvs from a try block that propagate to independently-compiled units, the separate unit must use single to annotate the propagated types within itself as single to ensure type consistency. Thus independent compilation becomes fully supported. For linking, to ensure that type consistency is kept, each compiled file can comprise of its object code and the extern types, so that type consistency can be checked. Hence independent compilation is enabled and safe.

A simple way to implement sepvs, compliant with independent compilation is as follows. Restrict sepvs to be such that whenever they are passed to a procedure, or stored in a data structure or a global variable, they are either demonstrably inbound or verified to be inbound by a compiler placed assertion. In other words a call or store operation has to be dominated or effectively dominated by a dereference operation on the concerned pointer or be assertable inbound. Effectively dominated means that each path involving a passed/stored pointer has dereference operation along the path without an intervening pointer arithmetic operation. This definition of sepvs is likely to meet common usage and allow intraprocedural checking to be enough for sepvs and support independent compilation while handling procedure calls and store/read data structures to take place. This is also compliant with encode/decode standards.

Intraprocedural Pundit-based analysis, for a procedure containing single qualified pointers is as follows: Uninitialized pointers (viz. NULL pointer), dereferenced pointers, malloc-ed objects (base pointers), call-returned sepv, read sepv (from global variable or data structure) all start with (external) excursion 0 (viz. “inbound”). From this set of program points, trace the forward paths noting maximum positive and negative excursion of the pointer till either another dereference on the pointer occurs or procedure ends. For the procedure, the maximum positive excursion and maximum negative excursion of any sepv along any control path comprises the sepv range for the procedure. The range for sepvs comprises the maximum and minimum over all procedures. For independent compilation ease, the sepv range can be user-specified, with the analysis above only verifying it. In the above, for non-constant pointer arithmetic, sepvs can require that such arithmetic dominate a dereference or be assertably inbound, allowing an assertion or the dereference check to be lifted to the arithmetic point ensuring that such arithmetic is always inbound. In the above, because of heapification of stack objects, the & operator applies only to malloc-ed objects and translates simply to a pointer arithmetic operation on the base pointer. In the above, add a read sepv local variable as a forward tracing point. In contrast to other read sepvs, a local variable starts with a pre-existing positive and negative excursion comprising the range preceding all the stores on the local variable in the procedure. For this, each store on the local variable has to be traced backwards to its dominating or effectively dominating “inbound” guarantors or assertions (e.g. dereferences, see list above). A read on the local variable can take the excursion from any of its stores and hence all stores are considered.

Tracing analysis is carried out as in Pundit as per Varma95, where each starting point traces out one pointer to an object, which in turn may be copied and further modified. Each pointer is represented by its own uv. Tracing proceeds intra-procedurally from the starting point through all paths, terminating when it reaches a dereference or end of procedure, or a loop. Stopping upon one pointer's dereference is justified, since other copied/modified pointers to the object are stored pointers (locally or otherwise), which are traced separately.

In the tracing, a procedure call is skipped. A procedure call represents irrelevant computation (for the analysis), or non-termination, or stack-unwinding (in case of longjmp), which reduces to either the computation beyond the call not being reached, or reached. By considering the reaching case, the results of the analysis are conservative. A procedure call may also represent a dereferencing of the traced pointer (if an alias of the uv is passed to the call and returned). So tracing past a call is not necessary, but is conservative.

A call returning an sepv is also one of the starting points of the tracing analysis.

In the above, excursion is defined as shown in the following example.

T*p=(T*) malloc(sizeof(T));
p++; p++; p−−; p−−;
*p= . . . ;

In the above, the excursion of the pointer is +2*sizeof(T), even though it is inbound when it is initialized and when it is dereferenced.

Single-qualified pointers are the only pointers requiring the excursion verification as above. As argued previously, pointers that remain inbound (most pointers) are excellent candidates for single-qualification (demonstrably inbound is based on dereferences/assertions, which are easily present/included). Even pointers that excurse outbounds in a limited manner (e.g. one past an array) are easy candidates for single qualification.

The present invention makes one key departure from the works mentioned in the section entitled “Background of the Invention” in that there is no capability store or table or page table in our work that is required to be looked up each time an object is accessed. Our notion of a capability is an object version that is stored with the object itself and thus is available in cache with the object for lookup within constant time. In effect, an object for us is the C standard's definition as suggested by ISO/IEC 9899:1999 C standard, 1999, ISO/IEC 14882:1998 C++ standard, 1998, Also, ISO/IEC 9899: 1999 C Technical Corrigendum, 2001, www.iso.org, namely, a storage area whose contents may be interpreted as a value, and a version is an instantiation or lifetime of the storage area. Similarly, object bound information is stored with the object itself.

With this, the overheads for spatial and temporal access error checking according to the present description can asymptotically be guaranteed to be within constant time. Furthermore, since each object has a version field dedicated to it, the space of capabilities in our work is partitioned at the granularity of individual objects and is not shared across all objects as in Austin et al., and W. Xu. D. C. DuVarney, and R. Sekar, “An efficient and backwards-compatible transformation to ensure memory safety of C programs”. Proc. 12th ACM SIGSOFT Int. Symposium on Foundations of Software Engineering (Newport Beach, Calif., USA, Oct. 31-Nov. 6, 2004). SIGSOFT '04/FSE-12. ACM. New York, N.Y., pp. 117-126. DOI=http://doi.acm.org/10.1145/1029894.1029913 (hereinafter referred to as Xu et al.) and is more efficient than a capability as a virtual page notion of Electric Fence, PageHeap and Dhurjati 1. This feature lets our versions be represented as a bitfield within the pointer word that effectively contains the base address of the referent (as an offset into a pre-allocated protected heap), which means that we save one word for capabilities in comparison to the encoded fat pointers of Austin et al., without compromising on the size of the capability space. Since versions are tied to objects, the object or storage space is dedicated to use solely by re-allocations of the same size (unless a garbage collector intervenes). This fixedness of objects is put to further use by saving the object/referent's size with the object itself (like version), saving another word from the pointer metadata compared to prior work.

These savings that we make on our pointer metadata are crucial in bringing our encoded pointers down to standard scalar sizes of one or two words in contrast to the 4-plus words size of Austin et al., and a similar price of Xu et al. Standard scalar sizes means that our encoded pointers assist backward compatibility, avail of standard hardware support for atomic reads and writes, and can be meaningfillly cast to/from other scalars, and achieve higher optimization via register allocation and manipulation. These gains are critical for efficient implementation.

Without wishing to be bound by any particular hypothesis, the Applicant believes it is possible to reduce runtime security checking costs in safe systems to such levels that gains made from leveraging the security apparatus may outweigh the costs. The above hypothesis has been demonstrated for five benchmarks taken from string applications. However, these demonstrations are merely for exemplification purposes and should not be construed to limit the applicability of the method.

Dhurjati 1 is similar to the method proposed in the present disclosure in temporal access error checking, although they only cover dangling pointer checks for heap-allocated objects. The version numbers proposed in the present disclosure correspond to virtual page numbers in Dhurjati 1, except that virtual page numbers are shared and looked up via the hardware memory management unit (MMU). While only one version number is generated per allocated object in our scheme, a large object can span a sequence of virtual pages in Dhurjati 1, all of which populate the MMU and affect its performance. The version numbers proposed by the present disclosure are typed by object size and are table-free in terms of lookup. This implies that the object lookup cost is guaranteed to be constant when adopting the method of the present description, while for Dhurjati 1 it varies according to table size even if OS/hardware supported. For example consider a scenario when the table outgrows the number of pages held in hardware table. TLB misses cost are described as a concern in Dhurjati 1. There is also concern at the fact that an allocation/deallocation engenders a system call apiece which is expensive.

The present disclosure teaches a system that treats memory violations—temporal and spatial—in an integrated manner. The versions as per the present disclosure are substantially more efficient in the virtualization they offer compared to Dhurjati 1 wherein each object allocation, however small, blocks out a full virtual page size and large objects block out multiple virtual pages. By contrast, the virtualization overhead for our mechanism comprises a small constant addition to the object size. Virtual space overuse (simultaneously live objects) has no concomitant performance degradation for us, while in work of Dhurjati 1, it can cause paging-mechanism-related thrashing which would affect not only the application process, but also other processes in the machine.

The scalar, fat-pointer based technique suggested in the present disclosure has the ability of providing obtaining significant backwards compatibility in a manner independent of Ruwase et al. and Jones et al. Further, the present disclosure differs from Dhurjati 1 and its predecessors by not relying on any table lookup. The method also does not impose any object padding for out-of-bound pointers either. General pointer arithmetic (inbound/out-of-bound) over referent objects is also supported by the method of the present disclosure.

In contrast to Purify and Valgrind, the method of the present disclosure captures all dangling pointer errors and spatial errors (e.g. dereference of a reallocated freed object or dereference past a referent into another valid but separate referent). While Valgrind typically slows application performance by well over an order of magnitude, our work adds only limited constant costs to program operations. Also, Valgrind computes some false positives and false negatives within its framework compared to which our approach has no false positives.

In this section we characterize the cost constants of our work. For this, we have the 32-bit general implementation run on Dell Vostro 3550 with Ubuntu Linux 10.10, Intel Core i5-2450 processor, 2.5 GHz with turboboost up to 3.1 GHz, 2 GB RAM, using GCC 4.4.5 for compilation at —O3 level of optimization using clock( ) as the timing function. Times reported are average of 4 readings apiece with variation range less than 5%. The benchmarks are well known public code, comprising library routines taken from Gnu Libc 2.14 (http://www.gnu.org/software/libc/).

TABLE I
BENCHMARK TIMES AND SPEEDUP

Secure, Fully
Leveraged

| | Original | Time | |
|---|---|---|---|
| Benchmark | Time (ms) | (ms) | Speedup |
| strlen | 2698 | 293 | 9.21 |
| strchr | 430 | 453 | 0.95 |
| strncmp | 893 | 745 | 1.20 |
| strncat | 1555 | 470 | 3.31 |
| strpbrk | 1163 | 1160 | 1.00 |

Table 1 provides the time and speedup of individual routines. The time of the original benchmark is shown in the second column. The third column shows the same benchmark hand modified to be secure and to leverage the bounds information made available by the security apparatus. The speedup obtained as a result is shown in column 4.

String applications are extremely good applications for exercising the security apparatus because they are data structure intensive—string data structures. Each of the above applications is full of string accesses and manipulations. We discuss each of the applications individually in the subsections below.

### Strlen( )

Strlen( ) computes the length of a string by searching through it linearly for the \0 character. In order to speed up the search, strlen looks through the string a longword of bytes at a time, identifying if a longword contains a \0 byte or not. Prior to the longword searching loop, strlen undergoes an alignment loop where it advances its string pointer till the pointer reaches a long word boundary. In this process, if \0 is found, the routine returns the length of the string traversed thus far by computing pointer difference from the beginning of the string. The exit of the longword loop also comprises identifying the specific byte in the longword that is \0 and adding its offset to the length of the string upto the beginning of the longword as the answer. This \0 identification is implemented as a series of 4 or 8 \0-checking conditionals instead of a loop, depending on the word size of the machine.

The secure, bounds leveraging version of this routine has a user assertion that the string pointer argument is a live inbound pointer to a standalone string. The routine returns the inbound excursion space ahead of the pointer as the answer, without undergoing a loop computation. Thus regardless of whether a \0 is present or absent in the provided string, the procedure returns an answer correctly. This answer computation is simply an answer lookup from the secure system and does not comprise a loop computation and does not comprise excursing beyond the bounds of the allocated string unlike the unsafe, original routine. The original routine is unsafe because it looks at the memory one longword at a time, where the \0 may be an early byte in the longword, and thus looks past the \0 marker.

The impact of this transformation is shown in Table 1. This benchmark changes the computation pattern from an O(n) search to an O(1) lookup, so clear gains in terms of speedup are expected. The actual code exercised in the benchmark uses a longword-aligned string which exercises the longword loop for 25 iterations. Hence a speedup of over 9 shows that the O(1) cost breaks even in less than 3 iterations of the main loop.

### Strchr( )

Strchr( ) is structured similarly to strlen( ) in having an alignment loop followed by a longword by longword search loop with a loop-unrolled exit clause. Everywhere, the checking looks for a match with the searched for character or \0, with finding the character returning a pointer to the character as the answer or NULL (if the terminating \0 is reached first).

The secure, bounds leveraging version of this routine has a user assertion in the beginning that the string pointer in the argument string is live and inbound to a standalone string. The loops are recast to iterate in terms of the inbound forward excursion space available to the pointer instead of a memory-content-based search for the character \0. The modified longword-by-longword search loop carries out its iteration without the matching clause with \0 burdening its search. In the alignment loop and in the exit clause of the longword loop, the \0 checks are replaced by remaining-space==0 checks. Since there may be un-aligned characters left past the longword search space, the alignment loop is repeated after the longword loop to catch any matches in these characters. This extra loop is unlike the unsecure original strchr( ) that looks past these unaligned characters at the entire subsuming longword always. By contrast the secure version has an extra loop as it never accesses the string outside its defined bounds.

For the code above, the static analysis is able to establish that all dereferences are inbound and is able to use decoded pointers everywhere in the loops (barring when returning an encoded pointer as a result).

The impact of this transformation is shown in Table 1. Like strlen( ) this routine exercises the main loop for 25 iterations on a word-aligned string. Structurally, the change in the benchmark is the simplification of the conditional branching in the body of the loop (removal of \0 in longword check while character match check remains which means content-based branching remains), and the addition of an index-based conditional (a remaining-space==0 check) in the loop termination clause. The gains are thus offset, resulting in an overall slowdown of the benchmark by 5%.

### Strncat( )

Using a while loop searching character by character (and not longword by longword as in strlen( )), strncat( ) advances a first string's pointer to the \0 byte. Strncat( ) then copies n characters from a second string to the first string, overwriting its \0 character in the process. Each character is checked for being \0 prior to being written to the destination with \0 terminating the copying process. If no \0 is copied, then a \0 is written explicitly after the n characters. The copying is done using two while loops if n>4 (representing copying in unrolled loop chunks of 4 first) or one while loop (representing copying one character at a time in its loop body).

The secure, bounds leveraging version of this routine is not \0 based and hence the destination to which characters are written is provided explicitly as an argument pointer, with the procedure carrying out the characters writing as a side effect (returns void). At the head of this routine, a user assertion states that the string pointer arguments are live, inbound pointers to standalone strings. The inbound forward excursions available to the two pointers are compared with n to obtain the minimum of the three quantities, which is set to be the new n. The characters are copied from the source to the destination using two while loops as in the source program, except that no \0-checking takes place at all (of the source characters) in the loops.

The static analysis is able to establish that all pointer dereferences are inbound in the program above and that decoded versions of the argument pointers can be used throughout the loops.

The impact of this transformation is shown in Table 1. Like strlen( ), this benchmark eliminates a loop completely, so speedup gains commensurate with the work eliminated are expected. In the exercised code, since 100 bytes are copied at the end of a 100 byte string, the realization of a 3.3 fold speedup indicates that the work eliminated is more than half. The gain comes from the complete elimination of content-based conditionals (\0-check) in the copying loop, in addition to the elimination of the search loop.

### Strncmp( )

N characters of two strings are compared lexicographically. The structure comprises two while loops, similar to the copying process of strncat( ), wherein pointers to the two strings are kept and advanced together. The comparison ends if \0 is encountered or if the characters of the two strings differ.

The secure, bounds-leveraging version of this routine has a user assertion at its head stating that the two argument string pointers are live, inbound pointers to standalone strings. N is set to the minimum of itself and the inbound forward excursion spaces available to the two pointers. \0-checking within the body of the two loops is completely eliminated. Otherwise the structure of the two while loops is maintained as is.

The static analysis is able to establish for this program that all dereferences are inbound and that decoded pointers can be used for encoded pointers throughout the loops.

The impact of this transformation is shown in Table 1. The gain in this benchmark comprises a diluted version of the gain in strncat( ), because while the \0-check based on memory content in the loop body is completely eliminated, the conditional is not since character equality is still checked in the loop. The first loop locating the end of a first string is not a part of this computation and its elimination is not reflected in the gain.

### Strpbrk( )

Strpbrk( ) locates the first character in its first argument string that falls in the character set represented by its second argument string. It comprises two nested while loops, the outer one iterating on the first string's characters and the inner one comparing the present character of the first string with the second string's characters one by one, returning if a match occurs.

The secure, bounds leveraging version of strpbrk( ) has an assertion at the beginning of the procedure that the two argument string pointers are live and inbound into standalone strings. The code is modified to express the iterations of the two while loops in terms of the inbound forward excursions available to the two pointers. This re-expression of the original source code guarantees that regardless of the presence or absence of \0 in the argument strings, strpbrk( ) will not excurse beyond the allocated space of the two strings. The analysis is able to establish for the re-expressed code that all pointer dereferences are inbound and use the decoded representation of pointers throughout the loops.

The impact of this transformation is shown in Table 1. The structure of the loops in the original and the modified code is identical, except for removing a \0 check and replacing it with a remaining-space check on an index variable that is also kept up-to-date for the purpose. The loop iterates on the index variable, exiting when the space becomes 0 (or if a character match occurs). Looping around a register-maintained index variable is inexpensive and more amenable to optimization such as branch prediction (that by contrast is essentially random when based on memory content). The efficiency reflected in the performance of the benchmark that shows no gain or loss.

The steps of the illustrated method described above herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, micro controller, or state machine. A processor may also be implemented as a combination of computing devices, e.g., a combination of a DSP and a microprocessor, a plurality of microprocessors, one or more microprocessors in conjunction with a DSP core, or any other such configuration.

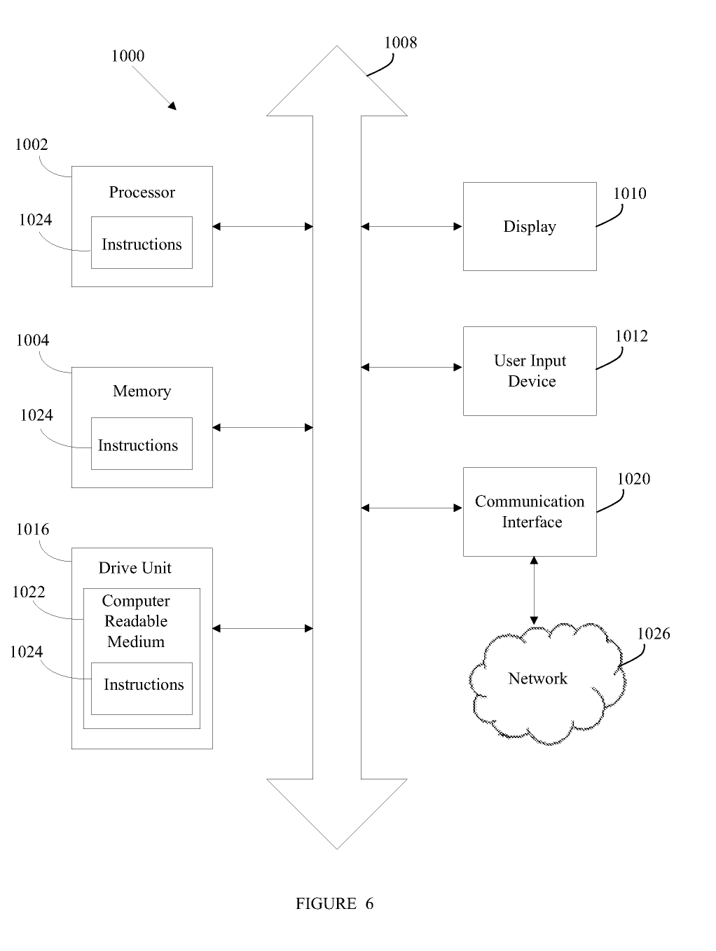

FIG. 6 illustrates a typical hardware configuration of a computer system, which is representative of a hardware environment for practicing the present invention. The computer system 1000 can include a set of instructions that can be executed to cause the computer system 1000 to perform any one or more of the methods disclosed. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a control system, a personal trusted device, a web appliance, or any other machine capable of executing a set of instructions (sequential or otherwise) that specify actions to be taken by that machine. Further, while a single computer system 1000 is illustrated, the term “system” shall also be taken to include any collection of systems or sub-systems that individually or jointly execute a set, or multiple sets, of instructions to perform one or more computer fimctions.

The computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data The processor 1002 may implement a software program, such as code generated manually (i.e., programmed).

The term “module” may be defined to include a plurality of executable modules. As described herein, the modules are defined to include software, hardware or some combination thereof executable by a processor, such as processor 1002. Software modules may include instructions stored in memory, such as memory 1004, or another memory device, that are executable by the processor 1002 or other processor. Hardware modules may include various devices, components, circuits, gates, circuit boards, and the like that are executable, directed, or otherwise controlled for performance by the processor 1002.

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the computer system 1000.

The computer system 1000 may also include a disk or optical drive unit 1016. The disk drive unit 1016 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000, or combinations thereof. The connection with the network 1026 may be a physical connection, such as a wired Ethernet connection or may be established wirelessly as discussed later. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11, 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature.

While specific language has been used to describe the disclosure, any limitations arising on account of the same are not intended. As would be apparent to a person in the art, various working modifications may be made to the process in order to implement the inventive concept as taught herein.

Without wanting to be tied to any hypothesis, the Applicant believes that it is possible to reduce runtime security checking costs in safe systems to such levels that gains made from leveraging the security apparatus even outweigh the costs. The Applicants have demonstrated this for benchmarks taken from string applications. Realizing such gains requires a highly efficient, optimizable runtime and capable static analyses. For this purpose, the Applicant has proposed a novel static analysis that is a first in secure program optimization in terms of being based on running a program symbolically at compile time. The benchmarks taken are merely for demonstration purposes and are of non-limiting nature.

We claim:

1. A method for enabling independent compilation in a computer system, comprising:
identifying unique layouts in a pre-processed file or translation unit of a program and assigning unique keys to all the identified unique layouts;
creating a local table and populating the same with the unique layouts and their associated unique keys;
repeating the aforesaid steps for all pre-processed files or translation units corresponding to the program to thereby generate a set of local tables, wherein each of the local table in the set corresponds to a particular file;
creating a global table and populating the same with layouts taken from the set of local tables, such that each entry in the global table is unique; and
substituting each layout in each local table by a pointer to the associated unique entry in the global table, thereby linking the local tables and the global table to enable independent compilation of each file in the program.

2. The method for enabling independent compilation in a computer system as claimed in claim 1, wherein assigning comprises assigning unique keys to all the identified unique layouts in a sequential order.

3. The method for enabling independent compilation in a computer system as claimed in claim 1, wherein a layout defines a pair comprising the global/mangled function name, and the complete type of the function, wherein for a layout, the function address or function pointer serves as the unique key and the tables are constructed as an association list of key layout pairs.

4. The method for enabling independent compilation in a computer system as claimed in claim 1, wherein the tables are constructed of function pointer, function record pairs, where the function record can be augmented further to include an encoded pointer value for the function.

5. The method for enabling independent compilation in a computer system as claimed in claim 1, wherein the pointer may be a live pointer, dangling pointer, inbound pointer, out-of-bounds pointer, uninitialized pointer, manufactured pointer or hidden pointer.

6. The method for enabling independent compilation in a computer system as claimed in claim 1, wherein one or more files independently compiled of each other assigns different keys to the same layout or different layout to the same key.

7. The method for enabling independent compilation in a computer system as claimed in claim 1, wherein the independent compilation includes running or analyzing a secure or safe program symbolically wherein symbolic program values or unknown variables (uvs) are defined with the constraints of their storage memory comprising one stack frame or heap allocations and pointer/variable/parameter aliasing is constrained by the secure language context.

8. The method for enabling independent compilation in a computer system as claimed in claim 7, wherein a stack frame allocated variable or parameter is constrained to not be aliased with a pointer accessible location.

9. The method for enabling independent compilation in a computer system as claimed in claim 7, wherein a location in one heap allocated object is constrained to not be aliased with locations accessible to a pointer to different heap allocated object, regardless of pointer arithmetic carried out on the pointer.

10. The method for enabling independent compilation in a computer system as claimed in claim 7, wherein a location, variable or parameter containing a pointer scalar is constrained to not be aliased with a location or variable or parameter containing a non-pointer scalar.

11. The method for enabling independent compilation in a computer system as claimed in claim 7, wherein the secure dialect or language of the symbolic analysis is secure C/C++.

12. The method for enabling independent compilation in a computer system as claimed in claim 7, wherein analyzing comprises analyzing a secure or safe program statically wherein static program values are defined with the constraints of their storage memory comprising one stack frame or heap allocations and pointer/variable/parameter aliasing is constrained by the secure language context.

13. The method for enabling independent compilation in a computer system as claimed in claim 7, wherein analyzing the secure or safe program symbolically comprises symbolically tracing an assertion through the succeeding program to establish domination or effective domination of the assertion over dereferences and post-domination or effective post-domination of dereferences over the assertion, thereby allowing the asserted properties to represent bulk security checks for the dereferences.

14. The method for enabling independent compilation in a computer system as claimed in claim 7, wherein a symbolic static analysis is provided for verifying always-safe or always-unsafe dereferences according to assertions of liveness, inboundedness, excursion or type-layout properties in the program.

15. The method for enabling independent compilation in a computer system as claimed in claim 7, wherein analyzing the secure or safe program symbolically comprises symbolic tagging of the static program trace with program values is carried out to identify dereferences with program values in order to establish the coverage of the dereferences by the asserted properties.

16. The method for enabling independent compilation in a computer system as claimed in claim 14, wherein inserting liveness assertions post skipped calls in the intraprocedural analysis to allow the analysis to continue past free( ) calls that are happenable in the skipped calls.

17. The method for enabling independent compilation in a computer system as claimed in claim 7, wherein analyzing the secure or safe program symbolically comprises symbolically tracing a program and inferring an assertion to be placed at a program point is carried out so that the assertion dominates or effectively dominates succeeding dereferences and is post-dominated or effectively post-dominated by the dereferences such that the inferred properties for the assertion cover the dereferences and represent bulk security checks for the dereferences.

18. The method for enabling independent compilation in a computer system as claimed in claim 17, wherein the program points include the entry to a procedure and compliance operation positions including pointer casts, stored pointer reads, and pointer arithmetic operations.

19. The method for enabling independent compilation in a computer system as claimed in claim 17, wherein the inferred property to be asserted comprises disjunction of fast and slow checks allowing the common case to be processed fast.

20. The method for enabling independent compilation in a computer system as claimed in claim 19, wherein the fast and slow checks comprise type-layout checks, and loose or exact coverage checks in liveness, inboundedness or excursion clauses.

21. The method for enabling independent compilation in a computer system as claimed in claim 1, further comprising establishing encoded pointers passed to a try block in a program as single-word encoded pointers is carried out including supporting pointers in the program annotated with a single word qualifier.

22. The method for enabling independent compilation in a computer system as claimed in claim 1, further comprising propagating single-word pointers through a program by reachability of types is carried out that identifies pointers stored in objects pointed to by singleword pointers as singleword pointers and identifies pointers to objects containing singleword pointers as singleword pointers and identifies pointers co-habiting a data structure with a singleword pointer as singleword pointers.

23. The method for enabling independent compilation in a computer system as claimed in claim 22, wherein runtime implementation of singleword pointers increases the number of pointer bits available for versions and other metadata by reducing the object's base pointer by a constant number C of bits and increases the stride of base pointer by 2̂C bytes in order to leverage the minimum stride among adjacent heap objects.

24. The method for enabling independent compilation in a computer system as claimed in claim 22, wherein runtime implementation of doubleword pointers increases bits for their metadata in a similar manner.

25. The method for enabling independent compilation in a computer system as claimed in claim 22, wherein the identified singleword pointers are further verified to be implementable thus by a further intraprocedural static analysis that is simplified by requiring that pointers passed to a procedure (in a call) or stored in a data structure or a global variable be demonstrably inbound by either a dominating dereference or an analysis placed assertion.
